(19) United States
(12) Patent Application Publication
(10) Pub. No.: US 2026/0065504 A1
(43) Pub. Date: Mar. 5, 2026

(54) METHOD AND APPARATUS FOR DETECTING TRAILER PRESENCE BASED ON IMAGE ANALYSIS

(71) Applicant: Stoneridge Electronics AB, Solna (SE)

(72) Inventors: Yu HE, Dearborn Heights, MI (US); Utkarsh SHARMA, Farmington Hills, MI (US); Liang MA, Rochester, MI (US)

(21) Appl. No.: 18/815,937

(22) Filed: Aug. 27, 2024

(51) Int. Cl. G06T 7/73; B60R 1/26

(52) U.S. Cl. CPC G06T 7/74; B60R 1/26; B60R 2300/105; B60R 2300/307; G06T 2207/30241; G06T 2207/30252

(57) ABSTRACT

A method for a camera monitor system (CMS) includes utilizing a camera mounted to a tractor of a commercial vehicle to obtain an image feed having a region of interest that would depict a trailer if a trailer was connected to the tractor; detecting one or more features in the region of interest of an image from the image feed; comparing the one or more detected features to one or more reference features corresponding to presence of the trailer; and determining whether the trailer is attached to the tractor based on the comparing. A camera monitor system (CMS) is also disclosed.

### TECHNICAL FIELD

This disclosure relates to a camera monitor system (CMS), and more particularly to a CMS and method for detecting trailer presence based on image analysis.

### BACKGROUND

Vehicle camera systems for mirror replacement or for supplementing mirror views are utilized in commercial vehicles to enhance the ability of a vehicle operator to see a surrounding environment of the commercial vehicle. These systems are known as “camera monitor systems” (CMS), and they utilize one or more cameras mounted to a tractor of a commercial vehicle to provide an enhanced field of view to a vehicle operator of an area surrounding a trailer of the commercial vehicle. CMS may also include cameras in locations not typically associated with a mirror, such as a rear camera (e.g., a trailer camera) that records images of an area behind a vehicle, a camera that records an area in front of a vehicle, etc.

Due to the nature of commercial shipping, commercial vehicles frequently deliver and pick up new goods, which often involves attachment of trailers and detachment of trailers. It is known to detect trailer presence based on the force applied to a trailer hitch, but this detection method is not robust.

### SUMMARY

A method for a camera monitor system (CMS) according to an example embodiment of the present disclosure includes utilizing a camera mounted to a tractor of a commercial vehicle to obtain an image feed having a region of interest that would depict a trailer if a trailer was connected to the tractor; detecting one or more features in the region of interest of an image from the image feed; comparing the one or more detected features to one or more reference features corresponding to presence of the trailer; and determining whether the trailer is attached to the tractor based on the comparing.

In a further embodiment of the foregoing embodiment, the comparing the detected features to one or more reference features corresponding to presence of the trailer includes comparing the region of interest of the image to the region of interest of a preceding image from the camera. A trailer is known to be connected to the tractor in the preceding image.

In a further embodiment of any of the foregoing embodiments, the one or more reference features includes a plurality of reference features, and the determining includes determining that the trailer is attached based on at least five features in the region of interest of the image matching respective ones of the one or more reference features.

In a further embodiment of any of the foregoing embodiments, the method includes estimating, based on a steering wheel angle of the tractor, what trailer angle would be exhibited by the commercial vehicle if a trailer was connected to the tractor, and the image used for the detecting one or more features corresponds to the estimated trailer angle fulfilling a predefined trailer angle criterion.

In a further embodiment of any of the foregoing embodiments, the method includes automatically enabling a CMS feature based on the determining indicating that a trailer has been attached to the tractor.

In a further embodiment of any of the foregoing embodiments, the method includes automatically disabling a CMS feature based on the determining indicating that a trailer, which was previously attached to the tractor, is no longer attached to the tractor.

In a further embodiment of any of the foregoing embodiments, the CMS feature includes a panning feature.

In a further embodiment of any of the foregoing embodiments, the CMS feature includes a trailer trajectory display feature in which a predicted trajectory of the trailer is displayed in a cabin of the commercial vehicle.

In a further embodiment of any of the foregoing embodiments, the CMS feature includes a trailer wheelbase detection feature.

In a further embodiment of any of the foregoing embodiments, the method includes utilizing a Binary Robust Invariant Scalable Keypoints (BRISK) algorithm or a Speeded-Up Robust Features (SURF) algorithm for at least one of the detecting step and the comparing step.

A camera monitor system (CMS) according to an example embodiment of the present disclosure includes a camera mounted to a tractor of a commercial vehicle, and oriented to provide an image feed having a region of interest that would depict a trailer if a trailer was connected to the tractor. The CMS also includes processing circuitry operatively connected to memory and configured to utilize the camera to obtain the image feed, detect one or more features in the region of interest of an image from the image feed, compare the one or more detected features to one or more reference features corresponding to presence of the trailer, and determine whether the trailer is attached to the tractor based on the comparing.

In a further embodiment of the foregoing embodiment, to perform the comparison, the processing circuitry is configured to compare the region of interest of the image to the region of interest of a preceding image from the camera, wherein a trailer is known to be connected to the tractor in the preceding image.

In a further embodiment of any of the foregoing embodiments, the one or more reference features includes a plurality of reference features. To perform the determination, the processing circuitry is configured to determine that the trailer is attached based on at least five features in the region of interest of the image matching respective ones of the one or more reference features.

In a further embodiment of any of the foregoing embodiments, the processing circuitry is configured to estimate, based on a steering wheel angle of the tractor, what trailer angle would be exhibited by the commercial vehicle if a trailer was connected to the tractor. The image used for the detection of the one or more features corresponds to the estimated trailer angle fulfilling a predefined trailer angle criterion.

In a further embodiment of any of the foregoing embodiments, the processing circuitry is configured to automatically enable a CMS feature based on the determining indicating that a trailer has been attached to the tractor.

In a further embodiment of any of the foregoing embodiments, the processing circuitry is configured to automatically disable a CMS feature based on the determination indicating that a trailer, which was previously attached to the tractor, is no longer attached to the tractor.

In a further embodiment of any of the foregoing embodiments, the CMS feature includes a panning feature.

In a further embodiment of any of the foregoing embodiments, the CMS feature includes a trailer trajectory display feature in which a predicted trajectory of the trailer is displayed in a cabin of the commercial vehicle.

In a further embodiment of any of the foregoing embodiments, the CMS feature includes a trailer wheelbase detection feature.

In a further embodiment of any of the foregoing embodiments, the processing circuitry is configured to utilize a Binary Robust Invariant Scalable Keypoints (BRISK) algorithm or a Speeded-Up Robust Features (SURF) algorithm for at least one of the detection and the comparison.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The disclosure can be further understood by reference to the following detailed description when considered in connection with the accompanying drawings wherein:

FIG. 1 is a schematic front view of a commercial truck with a camera mirror system (CMS) used to provide at least Class II and Class IV views.

FIG. 2 is a schematic birds-eye view of the commercial truck of FIG. 1 with a CMS providing Class II, Class IV, Class V, Class VI, and Class VIII views.

FIG. 3 is a schematic top view of an example vehicle cabin interior.

FIG. 4 is a perspective view of the vehicle cabin interior of FIG. 3.

FIG. 5 is an example CMS image with no trailer connected.

FIG. 6 is an example CMS image with a trailer connected.

FIG. 7 is a flowchart of an example method for a CMS for determining whether a trailer is connected to a tractor based on image analysis.

FIG. 8 is a schematic view of a CMS image with a trailer angle of approximately 30°.

### DETAILED DESCRIPTION

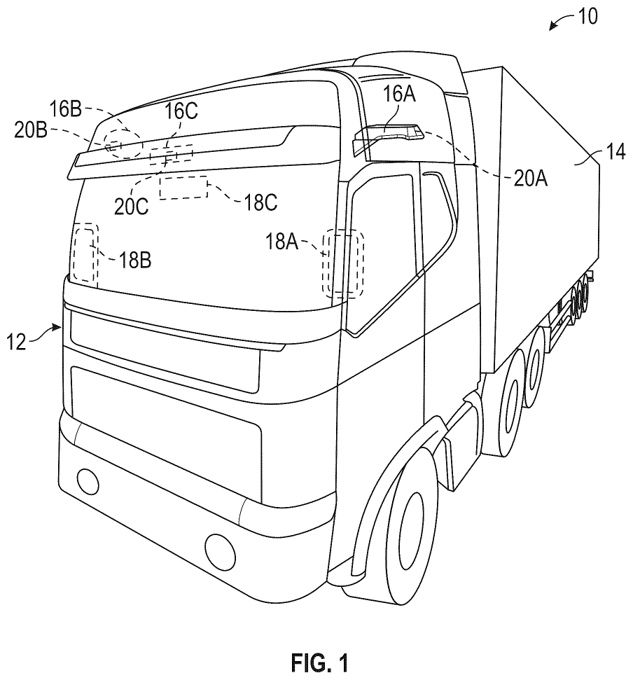

Schematic views of a commercial vehicle 10 are illustrated in FIGS. 1-4. The commercial vehicle 10 includes a vehicle cab or “tractor” 12 for pulling a trailer 14, where the trailer 14 pivots with respect to the tractor 12 during turns, causing an angle to form between a central longitudinal axis L1 of the tractor 12 and a central longitudinal axis L2 of the trailer 14. Although the commercial vehicle 10 is depicted as a commercial truck with a single trailer in this disclosure, it is understood that other commercial vehicle configurations may be used (e.g., different types or quantities of trailers).

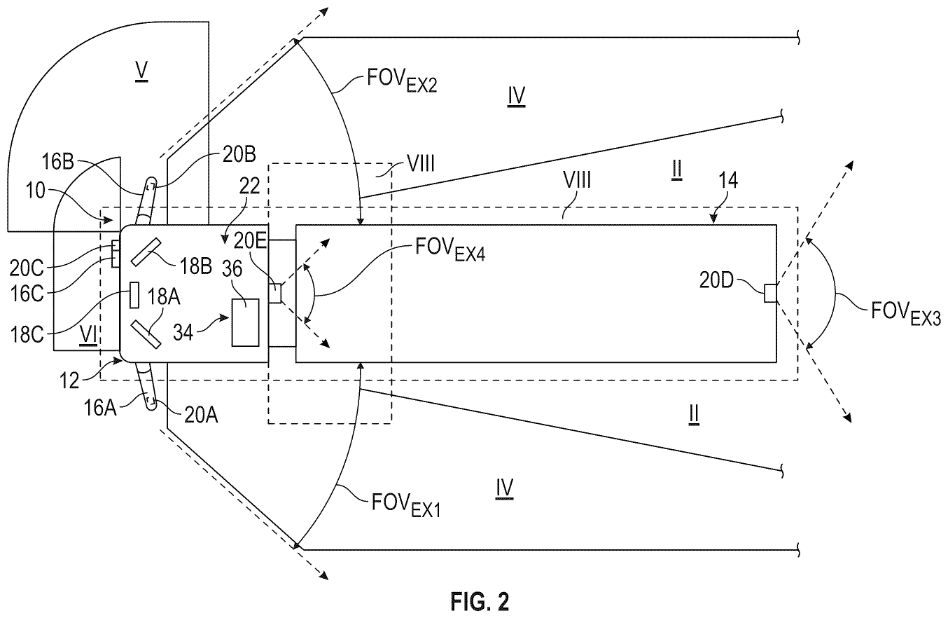

A pair of camera arms 16A-B include a respective base that is secured to, for example, the tractor 12. A pivoting arm is supported by the base and may articulate relative thereto. At least one rearward facing camera 20A-B is arranged respectively on or within the camera arms 16A-B. The exterior cameras 20A-B respectively provide an exterior field of view FOV_{EX1}, FOV_{EX2} that each include at least one of Class II and Class IV views (FIG. 2), which are legally prescribed views in the commercial trucking industry.

The Class II view on a given side of the commercial vehicle 10 is a subset of the class IV view of the same side of the commercial vehicle 10. Multiple cameras may also be used in each camera arm 16A-B to provide these views, if desired. Class II (narrow) and Class IV (wide angle) views are defined in European R46 legislation, for example, and the United States and other countries have similar drive visibility requirements for commercial trucks. Any reference to a “Class” view is not intended to be limiting, but is intended as an example of the type of view provided to a display from a particular camera.

Each camera arm 16A-16B may also provide a housing that encloses electronics, e.g., a controller, that are configured to provide various features of the CMS 15. The camera arms 16A-B may be mounted either at a roof-mount location over the cab door (as shown), or on a door-mounted bracket or station, for example.

If video of Class V and/or Class VI views is also desired, a camera housing 16C and camera 20C may be arranged at or near the front of the commercial vehicle 10 to provide those views (FIG. 2).

A backup camera 20D may be provided which provides a field of view FOV_{EX3}. The backup camera 20D may be mounted at a top/centerline of the trailer, at a bumper/bed level of the trailer, or at a top-corner of the back of the trailer, for example. Alternatively, or in addition to the rear trailer camera, a “fifth wheel camera” 20E may be provided that is mounted to a rear of the tractor 12 and that provides a field of view FOV_{EX4}. The fifth wheel camera 20E may be mounted anywhere between the lateral plane of the fifth wheel fixture and the top/roof edge of the tractor, for example.

In FIG. 2, tractor 12 has a central longitudinal axis L1, and trailer 14 has a central longitudinal axis L2, and the commercial vehicle 10 has a trailer angle of 0°, such that the axes L1, L2 are not angled with respect to each other. However, when the commercial vehicle 10 turns, the trailer angle increases to non-zero values.

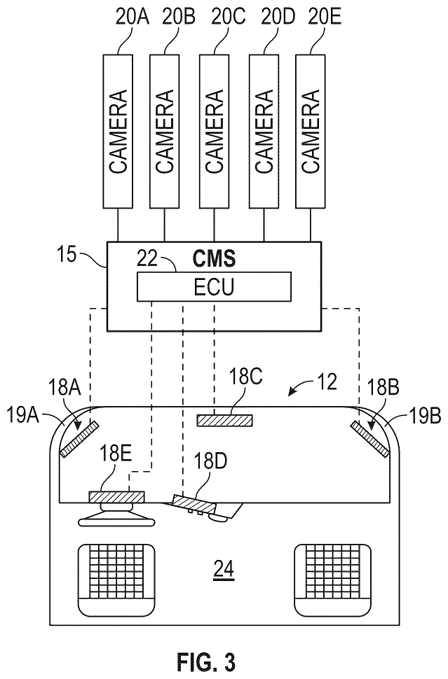

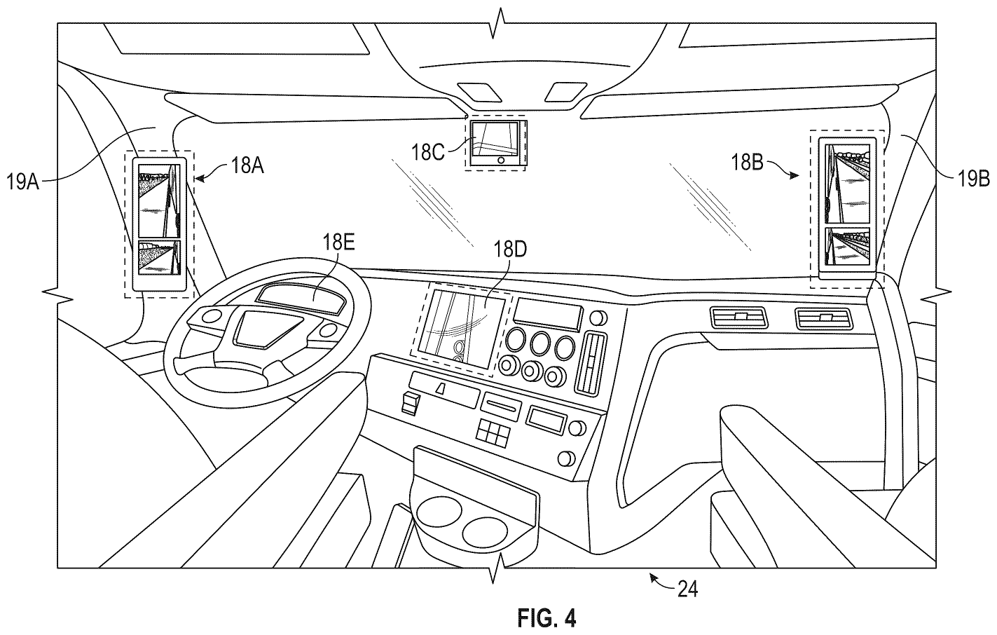

FIG. 3 is a schematic top view of an example interior of vehicle cabin 24, and FIG. 4 is a perspective view of the interior of vehicle cabin 24. Referring now to FIGS. 3-4 with continued reference to FIGS. 1-2, electronic displays 18A-E (e.g., which may be video displays, such as LCD displays) and cameras 20A-E are shown. The various electronic displays 18A-E and cameras 20A-E are part of a camera monitor system (CMS) 15, and therefore act as CMS displays and CMS cameras. As used herein, a “CMS camera” 20 is a camera configured to record images of an environment surrounding a commercial vehicle 10, and a “CMS display” 18 is an electronic display (e.g., an LCD) that is configured to display image feeds from those cameras.

The CMS 15 includes a CMS electronic control unit (ECU) 22 that acts as a controller and includes processing circuitry that supports operation of the CMS 15. The CMS ECU 22 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The CMS displays 18A-B are arranged on each of the driver and passenger sides within the vehicle cab 12 on or near the A-pillars 19A-B to display Class II and Class IV views on its respective side of the commercial vehicle 10, which provide rear facing side views along the commercial vehicle 10 that are captured by the exterior cameras 20A-B.

As discussed above, if video of Class V and Class VI views are also desired, the camera housing 16C and camera 20C may be arranged at or near the front of the commercial vehicle 10 to provide those views (FIG. 2). In the example of FIG. 3, additional displays 18C-E are provided. Display 18C is arranged in the interior of vehicle cabin 24 near the top center of the windshield may be used to display the Class V and Class VI views, which are toward the front of the commercial vehicle 10, or a backup camera view (from camera 20D or 20E) to the driver. Display 18D is provided in a center console area of the interior of vehicle cabin 24, and may be used for other purposes, such as navigation, infotainment, etc. Display 18E may be part of an instrument cluster, for example.

If video of Class VIII views is desired, camera housings can be disposed at the sides and rear of the commercial vehicle 10 to provide fields of view including some or all of the Class VIII zones of the commercial vehicle 10. In such examples, one of the displays 18C-E may include one or more frames displaying the Class VIII views. The displays 18A, 18B, 18C face a driver region within the interior of vehicle cabin 24 where an operator is seated on a driver seat.

If desired, the camera arms 16A-B may include conventional mirrors integrated with them as well, although the CMS 15 may be used to entirely replace mirrors. In additional examples, each side can include multiple camera arms, with each arm housing one or more cameras and/or mirrors.

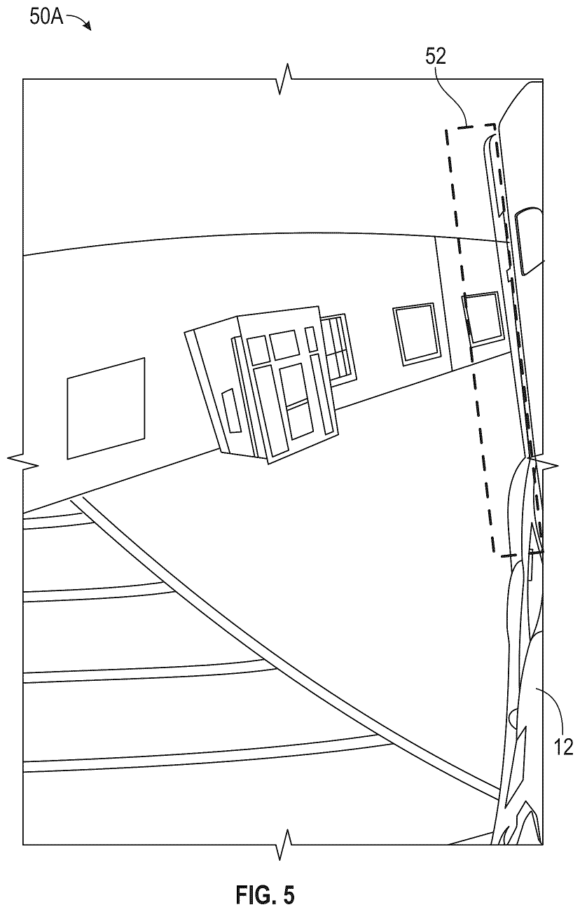

FIG. 5 is an example CMS image 50B from a tractor-mounted camera 20 (e.g., camera 20A) when no trailer 14 is connected to tractor 12. As shown, an example region of interest (ROI) 52 is provided that would depict a trailer 14 if a trailer 14 was connected to the tractor 12, and the commercial vehicle 10 had a trailer angle of approximately 0° between the axes L1, L2 of FIG. 2.

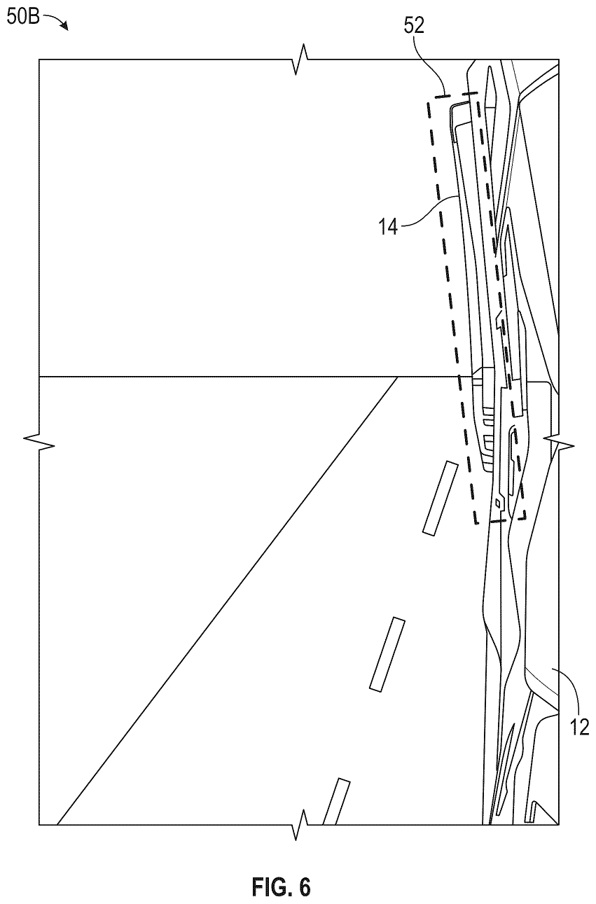

FIG. 6 is an example CMS image 50B from a tractor-mounted camera 20 (e.g., camera 20A) when trailer 14 is connected to the tractor 12. In the image 50B, a trailer 14 is visible in the ROI 52. Of course, it is understood that the ROI 52, which correspond to a trailer angle of 0° is only an example, and that other ROIs corresponding to other non-zero trailer angles (e.g., of 30°) may be used instead.

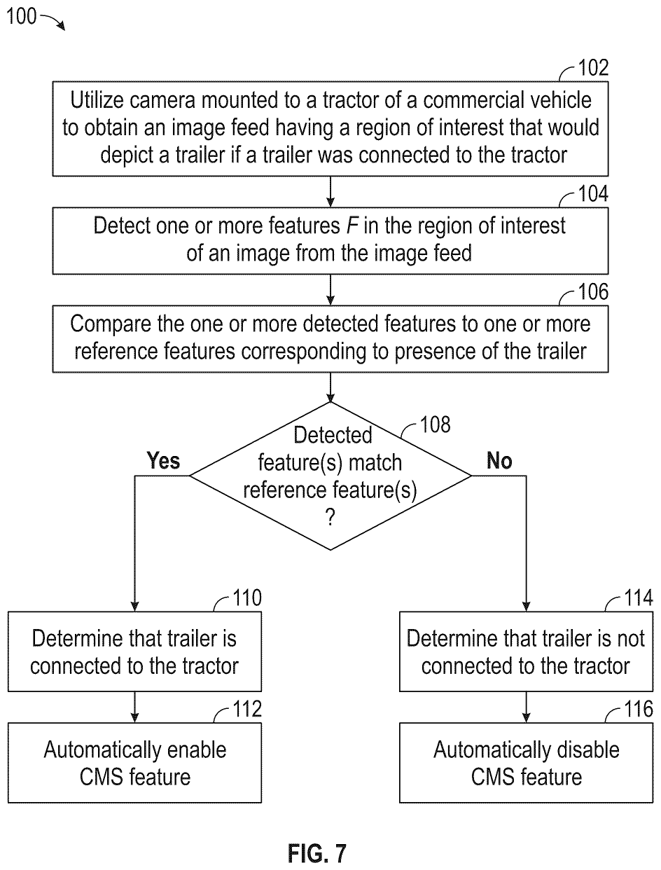

FIG. 7 is a flowchart of an example method 100 for a CMS 15 for determining whether a trailer 14 is connected to a tractor 12 based on image analysis. The method 100 may be performed by ECU 22, for example.

The ECU 22 utilizes a camera 20 mounted to the tractor 12 of commercial vehicle 10 to obtain an image feed having a ROI 52 that would depict a trailer 14 if a trailer 14 was connected to the tractor 12 (step 102).

The ECU 22 detects one or more features F_{N} in the ROI 52 of an image from the image feed of step 102, which is from the CMS camera 20 (step 104). The ECU 22 compares the one or more detected features F_{N} to one or more reference features F_{REF} corresponding to presence of a trailer 14 (step 106), and based on the comparison of step 106 determines whether the one or more detected features F_{N} match the one or more reference features F_{REF} (step 108). In one or more embodiments, the ECU 22 requires that at least five features match (i.e., are sufficiently the same as) reference features for step 206 to have a “yes”output.

In one or more embodiments, the ECU 22 utilizes a Binary Robust Invariant Scalable Keypoints (BRISK) algorithm and/or a Speeded-Up Robust Features (SURF) algorithm for at least one of the detecting step 104 and the comparing step 106.

The ECU 22 determines whether the trailer is attached to the tractor based on the comparing, as shown in steps 108-110. If the detected feature(s) match the reference feature(s) (a “yes” to step 108), then the ECU 22 determines that a trailer 14 is connected to the tractor 12 (step 110), and the ECU 22 automatically enables a CMS feature (step 112). The automatically enabled CMS feature may include any one or combination of the following:
A panning feature, whereby the ECU 22 pans a field of view of the CMS display 20 upon which the image feed from step 102 is displayed (e.g., pan field of view on display 18A which displays an image feed from camera 20A).
A trailer trajectory display feature in which a predicted trajectory of the trailer 14 is displayed in cabin 24 of the commercial vehicle 10 on one of the displays 18.
A trailer 14 wheelbase detection feature, which is performed in connection with the display of the predicted trajectory of the trailer 14.

If the detected feature(s) do not match the reference feature(s) (a “no” to step 108), the ECU 22 determines that trailer 14 is not connected to the tractor 12 (step 114), and the ECU automatically disables a feature of the CMS 15 (step 116). The features that are automatically disabled may include any one or combination of the features discussed above in connection with step 112, for example.

In one or more embodiments, the ECU 22 is configured to use a kinematic model of the commercial vehicle 10 to estimate a trailer angle that would be exhibited if a trailer 14 was attached to the tractor 12. An example kinematic model is discussed in U.S. patent application Ser. No. 18/116,627, which utilizes inputs such as vehicle velocity, tractor steering angle, trailer length, etc., and is incorporated by reference herein in its entirety.

In such embodiment(s), the ECU 22 utilizes the kinematic model to estimate, based on a steering wheel angle of the tractor 12, what trailer angle would be exhibited by the commercial vehicle 10 if a trailer 14 was connected to the tractor 12.

In one or more embodiments, the reference features utilized in step 106 correspond to features extracted from a CMS camera 20 of the commercial vehicle 10 when the kinetic model indicates that the trailer angle (if a trailer 14 was attached) meets a predefined trailer angle criterion (e.g., having a predefined value, such as 30°, or being within a predefined range, such as 25°-35°degrees).

In one or more such embodiments, if the estimated trailer angle does not fulfill the predefined trailer angle criterion, the ECU 22 does not perform step 104 and/or step 106.

A benefit of utilizing images recorded at a non-zero trailer angle is that if a trailer 14 is connected to the tractor 12, more of the trailer 14 is visible, which can make the feature detection process of step 104 more robust.

In one or more embodiments, the ECU 22 can provide a more granular output for steps 110, 114 based on whether a trailer was attached during a last monitoring time period. For example, if a trailer 14 was attached during a preceding monitoring period, then step 110 may correspond to a determination that the trailer 14 is still connected. Conversely, if a trailer 14 was not attached during the preceding monitoring period, then step 110 may correspond to a determination that a trailer has been connected since the preceding monitoring period.

Similarly, if a trailer 14 was attached during a preceding monitoring period, then step 114 may correspond to a determination that the trailer 14 has been decoupled from the tractor 12. Conversely, if a trailer 14 was not attached during the preceding monitoring period, then step 114 may correspond to a determination that the commercial vehicle 10 continues to have no trailer 14 attached to the tractor 12.

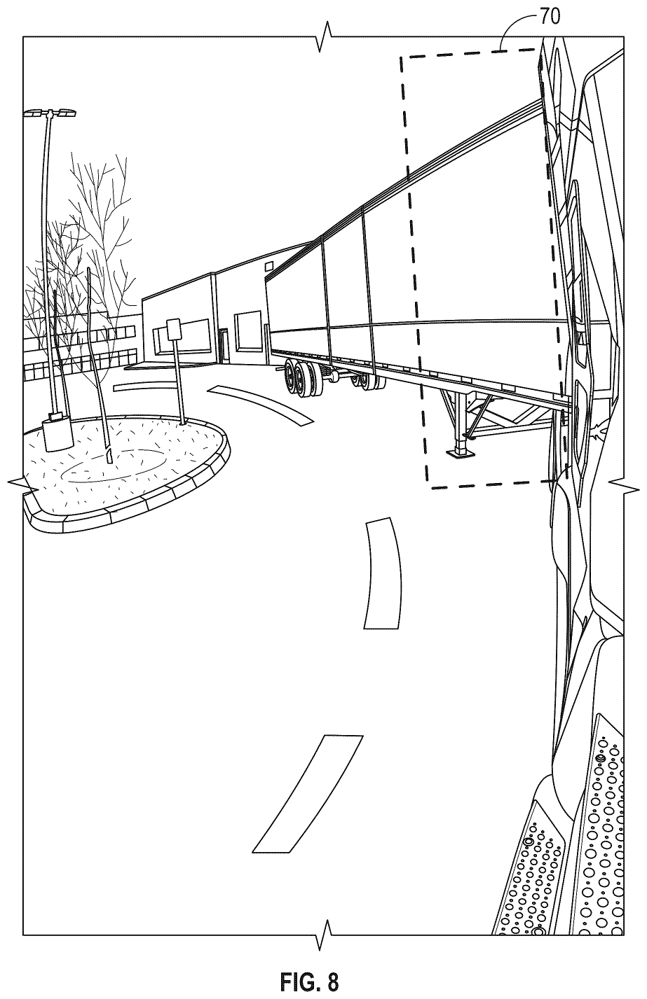

FIG. 8 is a schematic view of a CMS image with a trailer angle of approximately 30°. As shown in the image, a significant portion of the trailer 14 is visible in the ROI 70, especially compared to the ROI 52 of FIGS. 5-6, which correspond to a trailer angle of approximately 0°.

Although example embodiments have been disclosed, a worker of ordinary skill in this art would recognize that certain modifications would come within the scope of the claims. For that reason, the following claims should be studied to determine their true scope and content.

What is claimed is:

1. A method for a camera monitor system (CMS), comprising:
utilizing a camera mounted to a tractor of a commercial vehicle to obtain an image feed having a region of interest that would depict a trailer if a trailer was connected to the tractor;
detecting one or more features in the region of interest of an image from the image feed;
comparing the one or more detected features to one or more reference features corresponding to presence of the trailer; and
determining whether the trailer is attached to the tractor based on the comparing.

2. The method of claim 1, wherein said comparing the detected features to one or more reference features corresponding to presence of the trailer comprises:
comparing the region of interest of the image to the region of interest of a preceding image from the camera, wherein a trailer is known to be connected to the tractor in the preceding image.

3. The method of claim 1, wherein:
the one or more reference features includes a plurality of reference features; and
said determining comprises determining that the trailer is attached based on at least five features in the region of interest of the image matching respective ones of the one or more reference features.

4. The method of claim 1, comprising:
estimating, based on a steering wheel angle of the tractor, what trailer angle would be exhibited by the commercial vehicle if a trailer was connected to the tractor;
wherein the image used for said detecting one or more features corresponds to the estimated trailer angle fulfilling a predefined trailer angle criterion.

5. The method of claim 1, comprising:
automatically enabling a CMS feature based on the determining indicating that a trailer has been attached to the tractor.

6. The method of claim 1, comprising:
automatically disabling a CMS feature based on the determining indicating that a trailer, which was previously attached to the tractor, is no longer attached to the tractor.

7. The method of claim 6, wherein the CMS feature comprises a panning feature.

8. The method of claim 6, wherein the CMS feature comprises a trailer trajectory display feature in which a predicted trajectory of the trailer is displayed in a cabin of the commercial vehicle.

9. The method of claim 6, wherein the CMS feature comprises a trailer wheelbase detection feature.

10. The method of claim 1, comprising utilizing a Binary Robust Invariant Scalable Keypoints (BRISK) algorithm or a Speeded-Up Robust Features (SURF) algorithm for at least one of said detecting step and the comparing step.

11. A camera monitor system (CMS), comprising:
a camera mounted to a tractor of a commercial vehicle, and oriented to provide an image feed having a region of interest that would depict a trailer if a trailer was connected to the tractor; and
processing circuitry operatively connected to memory and configured to:
utilize the camera to obtain the image feed;
detect one or more features in the region of interest of an image from the image feed;
compare the one or more detected features to one or more reference features corresponding to presence of the trailer; and
determine whether the trailer is attached to the tractor based on the comparing.

12. The CMS of claim 11, wherein to perform the comparison, the processing circuitry is configured:
compare the region of interest of the image to the region of interest of a preceding image from the camera, wherein a trailer is known to be connected to the tractor in the preceding image.

13. The CMS of claim 11, wherein:
the one or more reference features includes a plurality of reference features; and
to perform the determination, the processing circuitry is configured to determine that the trailer is attached based on at least five features in the region of interest of the image matching respective ones of the one or more reference features.

14. The CMS of claim 11, wherein the processing circuitry is configured to:
estimate, based on a steering wheel angle of the tractor, what trailer angle would be exhibited by the commercial vehicle if a trailer was connected to the tractor;
wherein the image used for the detection of the one or more features corresponds to the estimated trailer angle fulfilling a predefined trailer angle criterion.

15. The CMS of claim 11, wherein the processing circuitry is configured to:
automatically enable a CMS feature based on the determining indicating that a trailer has been attached to the tractor.

16. The CMS of claim 11, wherein the processing circuitry is configured to:
automatically disable a CMS feature based on the determination indicating that a trailer, which was previously attached to the tractor, is no longer attached to the tractor.

17. The CMS of claim 16, wherein the CMS feature comprises a panning feature.

18. The CMS of claim 16, wherein the CMS feature comprises a trailer trajectory display feature in which a predicted trajectory of the trailer is displayed in a cabin of the commercial vehicle.

19. The CMS of claim 16, wherein the CMS feature comprises a trailer wheelbase detection feature.

20. The CMS of claim 11, wherein the processing circuitry is configured to utilize a Binary Robust Invariant Scalable Keypoints (BRISK) algorithm or a Speeded-Up Robust Features (SURF) algorithm for at least one of the detection and the comparison.
